(19) United States
(12) Patent Application Publication
(10) Pub. No.: US 2020/0019978 A1
(43) Pub. Date: Jan. 16, 2020

(54) SYSTEM AND METHOD FOR PRICE OPTIMIZATION OF STAY ACCOMMODATION RESERVATIONS USING BROAD AND DYNAMIC ANALYSES

(71) Applicant: YieldPlanet S.A., Warsaw (PL)

(72) Inventors: Ludwik Bielczynski, Warsaw (PL); Marcin Przybysz, Warsaw (PL); Claudio Limache, Warszawa (PL); Andrzej Pacut, Izabelin C (PL); Tomasz Sliwinski, Brwinöw (PL); Izabela Zoltowska, Warszawa (PL); Mariusz Kaleta, Warszawa (PL); Wlodzimierz Ogryczak, Warszawa (PL); Krzysztof Pienkosz, Warszawa (PL); Grzegorz Zalewski, Jozefow (PL); Piotr Palka, Warsaw (PL); Pawel Wawrzynski, Falenty Nowe (PL); Radoslaw Drozdz, Warszawa (PL)

(21) Appl. No.: 16/225,844

(22) Filed: Dec. 19, 2018

Related U.S. Application Data
(60) Provisional application No. 62/697,381, filed on Jul. 12, 2018.

(51) Int. Cl. G06Q 30/02; G06Q 10/02; G06Q 50/12; G06N 20/00

(52) U.S. Cl. CPC G06Q 30/0206; G06N 20/00; G06Q 50/12; G06Q 10/02

(57) ABSTRACT

A system and method for dynamic pricing of short-term stay accommodations, using machine learning algorithms to set pricing based on a broad set of non-homogenous dynamic data that may affect pricing at the time of booking, including pricing of competitors, market forecasts of pricing, internal factors including room quality, customer behavior related to booking, environmental factors, events, and economic factors.

### CROSS-REFERENCE TO RELATED APPLICATIONS

This application claims priority to U.S. provisional patent application Ser. No. 62/697,381, titled “SYSTEM AND METHODS FOR PRICE STRUCTURE OPTIMIZATION”, which was filed on Jul. 12, 2018, the entire specification of which is incorporated herein by reference.

### BACKGROUND OF THE INVENTION

### Field of the Art

The disclosure relates to the field of infrastructure management, more specifically infrastructure management and pricing optimization especially for hotels.

### Discussion of the State of the Art

In the field of pricing optimization for hotels and similar businesses, key factors in the determination of optimal pricing are numerous and swiftly changing, including external and internal factors, which results in oftentimes missed opportunities for increased revenue due to non-optimized pricing structures. There exist dynamic pricing optimization systems for such businesses currently, but they fail to take into account a number of data sources and fail to swiftly optimize prices as these numerous factors continue to change, resulting in lost revenue.

The process of revenue management for a large business such as a hotel requires a fast response to changing external (market situation, competition pricing strategies, events, weather, potential guest perception of the hotel, and willingness to pay) and internal conditions of the hotel (state, and number of occupied and available rooms). Automation of dynamic pricing based on a multitude of data, and allocating the inventory to different distribution channels (Online Travel Agencies, OTAs; Central Reservation System, CRS; etc.) becomes a necessity for revenue managers operating in hotels independently of their size.

What is needed is a method and a system for dynamic and automated price selection that incorporates data from multiple sources, such as room availability, competitor pricing, demand, weather forecasts, and behavior characteristics of particular customers such as cancellation rate, online comments etc.

### SUMMARY OF THE INVENTION

The inventor has conceived and reduced to practice a system for dynamic revenue management that incorporates an analysis of a multitude of data, such as internal hotel's situation (available rooms, number and rates of reservations already made), market behavior comprising of competitors' behavior (historical and future prices and room availabilities), guest behavior (reservation and cancellation rates, price elasticity, reviews) and external factors (actual and forecasted weather conditions, events).

According to a preferred embodiment, a system for dynamic pricing and booking of short-term stay accommodation is disclosed, comprising: a property management engine, comprising at least a plurality of programming instructions stored in the memory of, and operating on at least one processor of, a computer system, wherein the plurality of programming instructions, when operating on the processor, cause the computer system to: receive and store real time information about properties, room availability, and reservations made; and send the real time information about properties, room availability, and reservations made to a price optimizing engine; and a price optimizing engine, comprising at least a plurality of programming instructions stored in the memory of, and operating on at least one processor of, a computer system, wherein the plurality of programming instructions, when operating on the processor, cause the computer system to: obtain a plurality of real time pricing information for short-term stay accommodations; obtain a plurality of data about external factors, both current and future, that might affect demand for short-term stay accommodations; dynamically set pricing for short-term stay accommodations based on the plurality of pricing information and the plurality of data about external factors, using machine learning algorithms; and send pricing and availability information to a booking engine; and a reservation management engine comprising at least a plurality of programming instructions stored in the memory of, and operating on at least one processor of, a computer system, wherein the plurality of programming instructions, when operating on the processor, cause the computer system to: receive pricing and availability information from the price optimizing engine; display the pricing and availability information to potential purchasers or their agents; allow purchasers or their agents to make short-term stay accommodation reservations based on the displayed pricing and availability information; and send the reservation information to the property management engine.

According to another preferred embodiment, a method for dynamic pricing and booking of short-term stay accommodation reservations is disclosed, comprising the steps of: receiving and storing information about properties including room availability and current reservations in a given hotel, using a property management engine; sending real-time information about properties, pricing, and other hotel information, to a price optimization engine; receiving from either a database or some other network-connected source of digital information, real-time information about accommodations and reservations in a hotel, into a price optimization engine; receiving from either a database or some other network-connected source of digital information, information about external factors including hotel reviews or inclement weather, that may affect short-term hotel stays, into a price optimization engine; use machine learning algorithms to dynamically determine optimal pricing for short-term stay accommodations in a hotel based on received external and hotel data; sending optimal pricing for short-term stay accommodations to a reservation management engine; displaying pricing and availability information to potential purchasers or their agents using a reservation management engine; allowing purchasers or their agents to make short-term stay accommodation reservations based on the displayed pricing and availability information; and sending the reservation information from the reservation management engine to the property management engine.

The accompanying drawings illustrate several aspects and, together with the description, serve to explain the principles of the invention according to the aspects. It will be appreciated by one skilled in the art that the particular arrangements illustrated in the drawings are merely exemplary, and are not to be considered as limiting of the scope of the invention or the claims herein in any way.

### BRIEF DESCRIPTION OF THE DRAWING FIGURES

FIG. 1 is a system diagram illustrating connections between key components in a price optimization system, according to a preferred aspect.

FIG. 2 is a system diagram illustrating sources of data bringing information to a central database for the system, according to a preferred embodiment.

FIG. 3 is a system diagram illustrating operating system sub-components for receiving and managing data, according to a preferred aspect.

FIG. 4 is a system diagram illustrating the data fields and sources used directly by a price optimization engine, according to a preferred aspect.

FIG. 5 is a diagram of a price optimization engine scheme, utilizing a market simulator, according to an aspect.

FIG. 6 is an exemplary illustration of a price-demand curve fitting data for a selected room and stay-date at a given location.

FIG. 7 is an exemplary graph for a selected stay-date of actual and forecasted competition prices in function of days to arrival, according to a preferred aspect.

FIG. 8 is a diagram illustrating a central reservation sub-system and its connection to an optimization engine, according to a preferred aspect.

FIG. 9 is a method diagram illustrating key steps taken in saving Prices, Availabilities and Restrictions (PARs), according to a preferred aspect.

FIG. 10 is a method diagram illustrating the preparation and distribution of PARs, according to a preferred aspect.

FIG. 11 is a block diagram illustrating an exemplary hardware architecture of a computing device.

FIG. 12 is a block diagram illustrating an exemplary logical architecture for a client device.

FIG. 13 is a block diagram showing an exemplary architectural arrangement of clients, servers, and external services.

FIG. 14 is another block diagram illustrating an exemplary hardware architecture of a computing device.

### DETAILED DESCRIPTION

The inventor has conceived, and reduced to practice, a system and method for price optimization of stay accommodation reservations using broad and dynamic analyses.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

It is important to note that multiple rates can (and typically do) exist for a given hotel. The invention solves the problem of creating the optimal set of rates with optimal set of restrictions. Also, this disclosure discusses various embodiments of the invention by referring to hotel management, hotel rates, and so forth; it should be understood by one having ordinary skill in the art that the focus on “hotels” herein is merely exemplary, and any hospitality or short-term lodging venues may be managed in accordance with the present invention.

Our invention uses flexible machine learning algorithms such as for example neural nets to come up with optimal pricing for a plurality of hotels.

### Conceptual Architecture

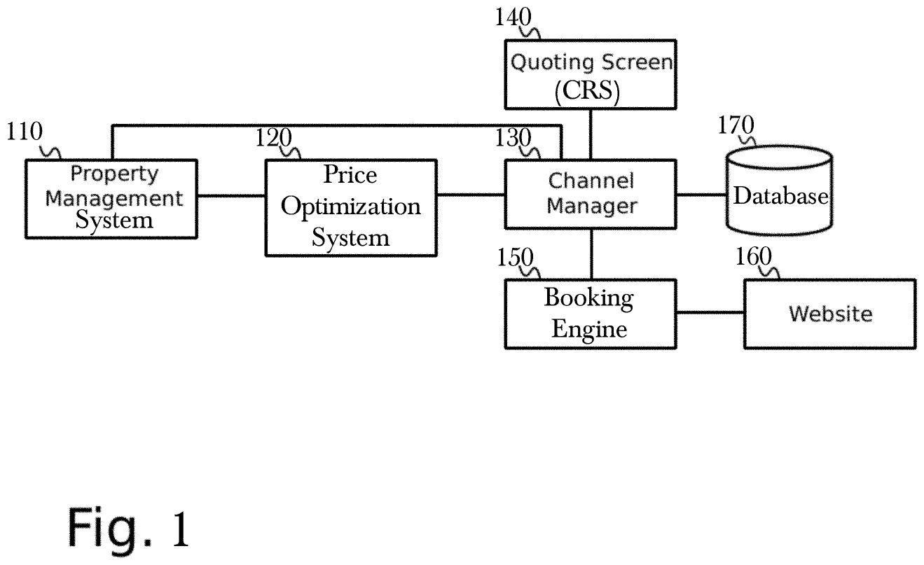

FIG. 1 is a system diagram illustrating connections between key components in a price optimization system, according to a preferred aspect. A property management engine 110 communicates with an optimizer engine 120, as well as with a channel manager 130. A property management engine 110 may communicate a variety of property and reservation information to an optimizer engine 120 to aid in the creation of an optimal price, and may receive data from a channel manager 130 if reservations are booked, which is a change in property data that a property management engine 110 would record for future pricing optimizations. A channel manager 130 is a sub-component within a client system 150 as shown on FIG. 1, and manages the flow of data between various components, such as reservation-making, data going into an optimization engine 120, data from such an engine being displayed on quote screens 140 and more. A reservation engine 150 is used for booking reservations made on a forward-facing website 160 operated by a customer or agent, for a stay at a hotel using the client system 150. A quoting screen 140 is used to display and browse quotes that are determined by an optimizer engine 120, and for a user to find varying room and plan prices at a hotel or hotels that may be interconnected on the same system.

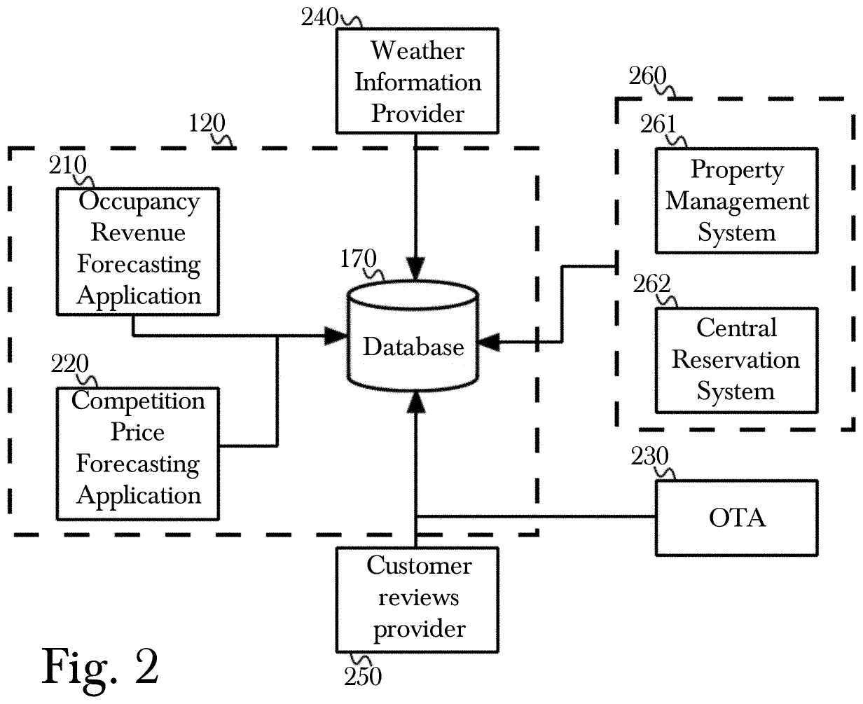

FIG. 2 is a system diagram illustrating sources of data bringing information to a central database for the system, according to a preferred embodiment. A database 170 is connected to a plurality of data sources, for the acquisition of diverse and large amounts of information that may affect analyses on customer interest and reservation expectation numbers for a business. Such data sources may include a weather information provider 240, which may provide either or both a weather forecast, and actual current weather conditions, which allows for changes in weather such as heavy snow or temperate sunshine to be taken into account during estimations of possible reservation expectations and aids in proper pricing to maximize profits. Another data source may include data from the parent hotel itself 260, including reservation data from a central reservation system 262, and data about the properties from a property management system 261. Such information from a hotel's digital systems 260 may allow for information regarding quality of rooms, booked reservations, occupancy, room cleaning status, and more, to be taken into account, which may affect optimal pricing and reservation expectations for rooms, after the data is collected into a database 170. Other data sources may include customer reviews from a customer review provider 250, such as YELP™ or GOOGLE™ reviews online, in which negative reviews about the hotel or specific rooms or suites may adversely affect optimal pricing based on a decrease in expected reservations, as opposed to increased expectations of reservations if positive reviews are left. An online travel agency (“OTA”) 230 may also provide data to a hotel, regarding the number of queries made about the hotel, number of customers currently travelling to the area the hotel is located in, and more, which may alter estimations of reservations in specific time periods or under certain conditions. Other data sources may include occupancy revenue forecasting 210, and competition price forecasting 220, both of which serve to forecast pricing and profitability of a parent hotel and its competitors. As part of a price optimization system 120, an occupancy revenue forecasting application 210 may provide data and calculations on estimated revenue from a given occupancy level, or provide chart or table data for numerous different occupancy levels and the expected revenue from such occupancy levels, while a competition price forecasting application 220 provides data on competition pricing which may help to adjust prices accordingly, in order to appeal to customers that may wish to make reservations. For example, in a high volume tourist area where reservations may be plentiful, under decent weather conditions, a hotel with luxurious suites may want to price above what an average hotel in the area may price because availability of customers is high, but may want to price slightly below what other luxury accommodations price at the time, so as to appeal to more of the tourists coming into the area.

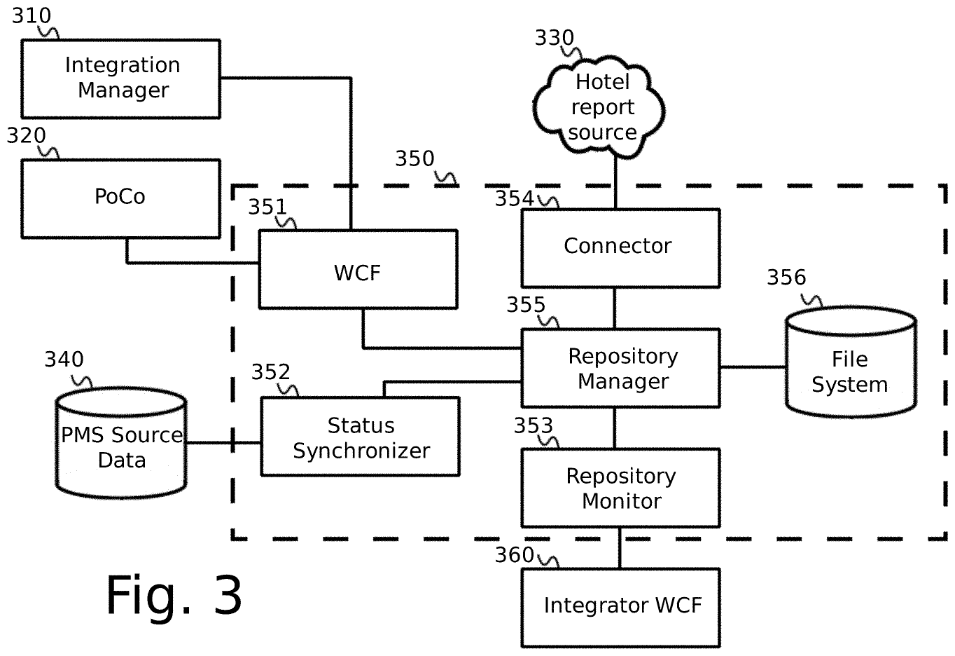

FIG. 3 is a system diagram illustrating operating system sub-components for receiving and managing data, according to a preferred aspect. A property management system interface (“PIOR”) 350 is connected to a hotel report source 330, which may or may not contain similar data to a hotel behavior database 170, and a PIOR 350 is also connected to an integration manager 310, a price optimizer configurator (“PoCo”) 320 which may be used in the process of configuring a price optimizer engine 120, a datastore containing property management system source data 340, and a WINDOWS COMMUNICATION FOUNDATION™ (WCF) integrator 360. The PIOR contains several subcomponents, including a WCF component 351 which is a runtime and set of API's within a client system, which are designed for service-based software. Also contained within the PIOR 350 are a connector component, which interfaces with a hotel report source 330 via a connector 354, a status synchronizer 352, which interfaces with the property management system source data 340 and a repository manager 355, a repository manager 355 which manages connections to and identities of all relevant data and data source connections for the system, a file system 356 for the PIOR system 350 to operate in, and a repository monitor 353 which monitors changes, additions, removals, or updates of any data or information within the repository manager 355.

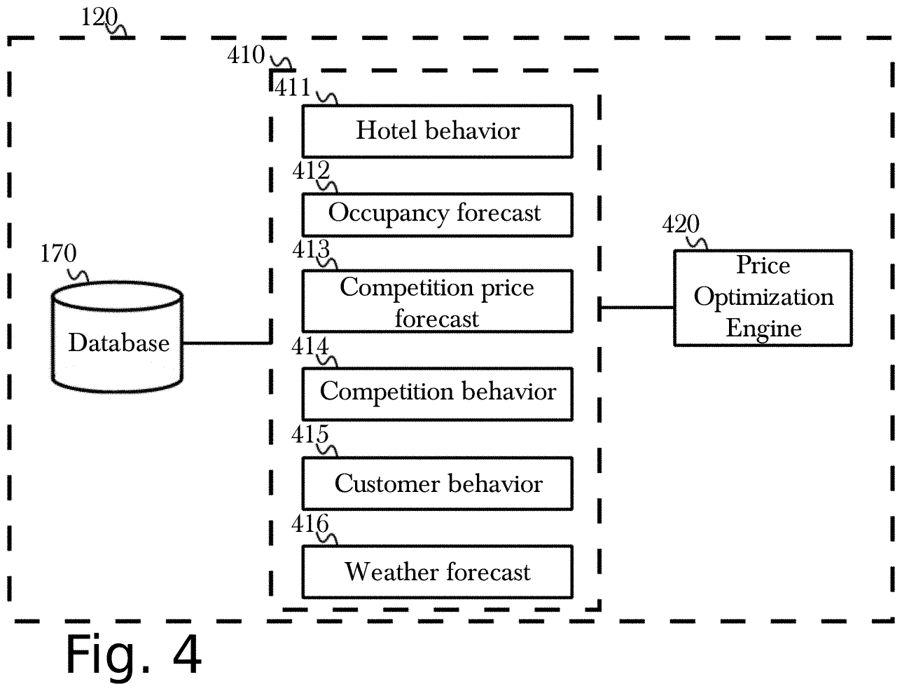

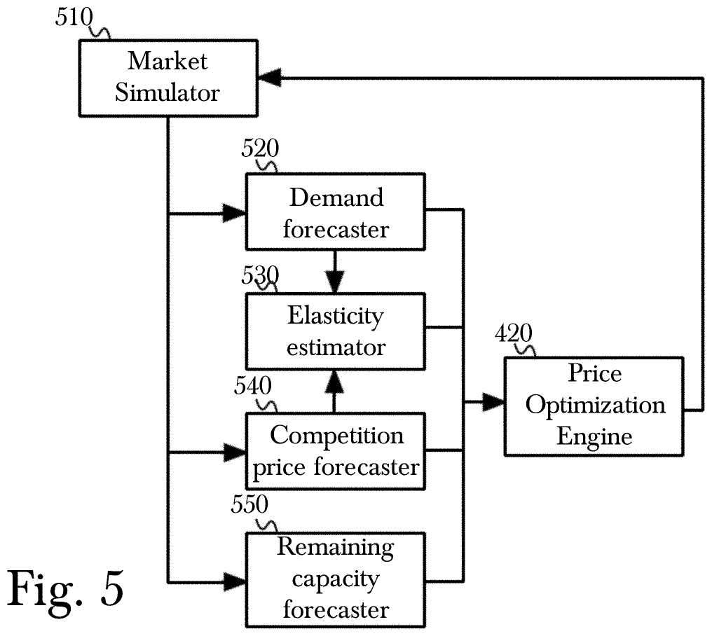

FIG. 4 is a system diagram illustrating the data fields and sources used directly by a price optimization engine, according to a preferred aspect. A database 170 which has connections to many data sources as shown in FIG. 2, may supply one or a plurality of data types 410 to a price optimization engine 420 as part of a price optimization system 120. These data types consist of hotel behavior data 411, an occupancy forecast 412, competition pricing forecasting 413, competition behavior 414, customer behavior estimates 415, and a weather forecast 416. Data from a parent hotel 411 is gathered from a property management system (“PMS”) 261, and central reservation system (“CRS”) 262, which provide information regarding hotel room quality, cleanliness, malfunctions or problems, occupancy, reservations, and the like. An occupancy forecast 412 is provided by an amalgam of data from a CRS 262 and OTA 230, which help to provide a baseline occupancy forecast based on possible incoming reservations and current reservations and available rooms. Other sources of data may further influence this calculation however, including customer reviews 250, which may negatively or positively impact an occupancy forecast, or current and forecasted weather 416 as provided by a weather data provider 240, which may dissuade customers from staying, or persuade them to make new reservations, depending on the climate. A competition pricing forecast 413 utilizes data from a competition price forecasting application 220 which notes not only current prices by competitors in a given area, but also forecasts what their prices may be in the immediate, near, or distant future, using some of the same data sources and calculations as used for a parent hotel, such as weather 416. Competition behavior 414 data is analyzed and provided by a price optimization engine 420, which consists of information gathered from online sources or may even be manually input, regarding the current actual pricing from competitors, or their advertising and outreach efforts. Customer behavior data 415 is analyzed using data from a customer review provider 250, as well as a hotel CRS 262, which may be analyzed together to determine customer interest in the hotel and trends of customer responses from previous and ongoing stays at a hotel. For example, negative reviews from multiple customers on the same group of rooms or suites may be analyzed and those particular rooms or suites may be priced lower so as to attract customers despite negative reviews from a customer review provider 250. Weather forecasting data 416 may also be provided by a weather information provider 240, which may unilaterally impact occupancy forecasting for a hotel. If a hotel is, for example, located in a temperate area, and they experience abnormally bad weather such as heavy snow and ice for several weeks, and the forecast indicates this will continue, then reservations in the near future may be deemed extremely unlikely. Conversely, extremely hot weather in a hot area may drive away potential customers, whereas temperate or cool weather may attract them and result in a positive shift in occupational forecasting 412. These data sources and analyses may be taken into consideration by a price optimization engine 420, as well as a market simulator as shown in FIG. 5.

FIG. 5 is a diagram of a price optimization engine scheme, utilizing a market simulator, according to an aspect. A market simulator 510 exists which may be fed data from a price optimization engine 420, which then simulates a market using all data available from a price optimization engine 420 to attempt to simulate the numbers and data of a plausible, real hotel marketplace. A demand forecaster 520, competition price forecaster 540, and remaining capacity forecaster 550 are fed data from a market simulator, in an attempt to cope with the simulated and dynamically changing data. A demand forecaster 520 may receive data from a market simulator 510 which includes all real or simulated data required to forecast an area's demand for hotel rooms, such as weather and location's general tourist attractiveness (for example, Las Vegas would have more attraction for tourists and hotel guests than, say, Albuquerque). A competition pricing forecaster 540 may receive the same or differing data, and both the competition pricing forecaster 540 and demand forecaster 520 may send the results of their analyses with the simulated data to an elasticity estimator 530 which will analyze the potential untapped customers and varying saturation of customers and room availability based on data input. A remaining capacity forecaster 550 may determine a possible range of availabilities in a parent hotel, given an optimized price from a price optimizer 420 and a simulated market 510. The combined data from these exercises may be fed back into a price optimization engine 420 so that data from simulated scenarios may be used to further refine pricing strategies for a parent hotel.

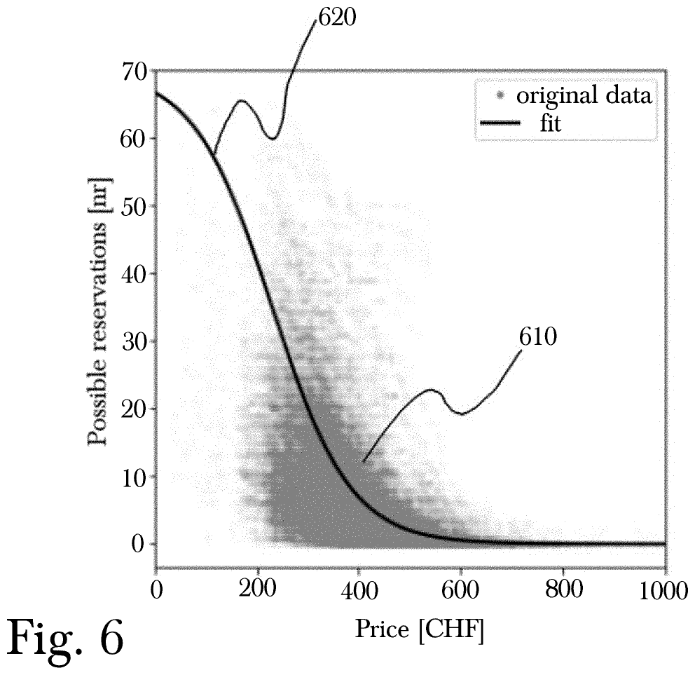

FIG. 6 is an exemplary illustration of a price-demand curve fitting data for a selected room and stay-date at a given location. A curve 620 is fit to match a large number of price points and possible reservation numbers 610 to provide a graphical representation of the falling of room rental availability as price scales up. This graph represents a key concept in the system, namely that possible reservations from customers and price are related, and not only can an optimal solution for maximum profit be found on this graph, but the “possible reservations” can be determined through a dynamic analysis of large datasets that may affect customer reservations. As seen in previous graphs through data collection and analysis, the “possible reservations” number may change rapidly, allowing for optimal pricing to change in response to many different events that may alter likelihood of reservations being made at a given price.

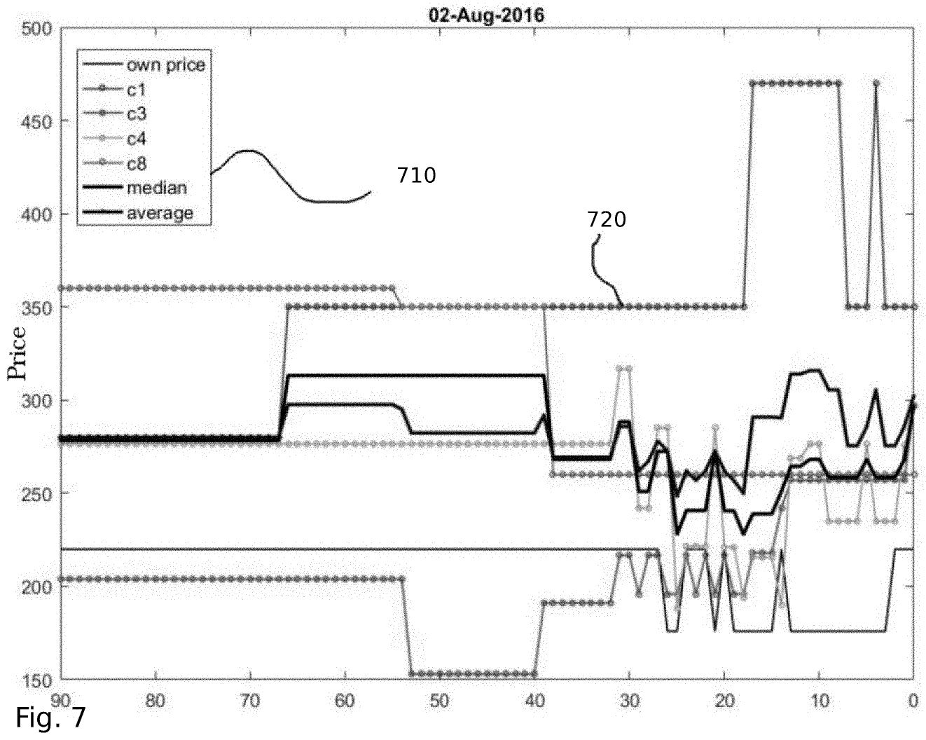

FIG. 7 is a graph of example competition pricing and self-pricing, and average pricing, for stays over a one-day period, according to a preferred aspect. For a given example list of competitors 710, a graph of pricing is constructed, illustrating varying performance for a given hotel compared to competitors 720. This graph may be visually viewed by human operators, or the data that generates the graph may be used programmatically by the system to determine efficacy in pricing schemes, to generate more optimized pricing.

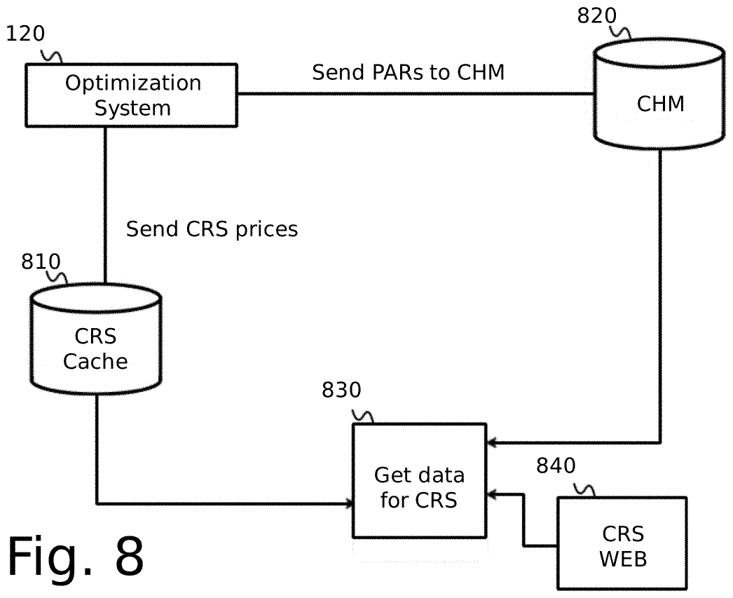

FIG. 8 is a diagram illustrating a central reservation sub-system and its connection to an optimization engine, according to a preferred aspect. An optimizer engine 120 is connected to a Central Reservation System (CRS) cache 810, which stores pricing information and more from the output of the optimizer engine 120. An optimizer engine 120 is further connected to a Cloud Hotel Management (CHM) system 820, through a network 120. Data for the function of the CRS is gathered 830 from this CRS cache 810, CRS 820, and the CRS' website 840, including actions taken from customers or agents and the results of those actions. The central reservation system 830 then may price rooms according to data received from an optimization system 120 and data from a hotel management system 820, as well as from a website 840 which may include user traffic data which may affect prices further.

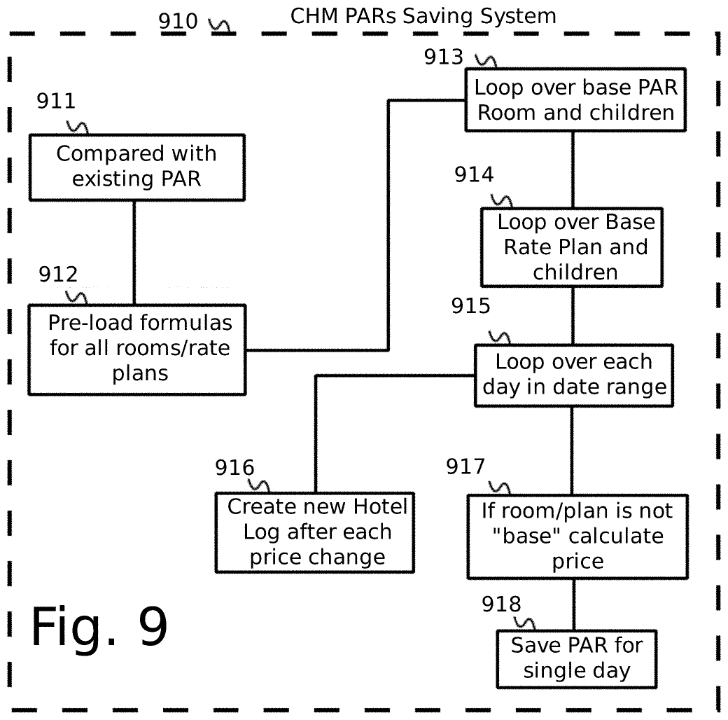

FIG. 9 is a method diagram illustrating key steps taken in the saving and storing of reservation parameters and formulae for pricing rooms and plans at a hotel, according to a preferred aspect. A Cloud Hotel Management (CHM) system 820 possesses a parameters saving method 910, comprising at least the tasks of comparing a parameter with existing parameters 911 as in the case of overwriting previous parameters, pre-loading formulas for all rooms or rate plans 912, looping over every base parameter room and children parameters 913, looping over base rate plans and children plans 914, then looping over each day in a given date range 915. Separately, tasks included in a parameter-saving method include creating a new hotel log after each price change 916, and also calculating the price of a non-base plan or room 917, and lastly saving the data on that day's pricing 918 for a given rate plan and room. The structure of 913, 914, and 915 can be compared to a nested “for” loop in some programming language implementations, for example.

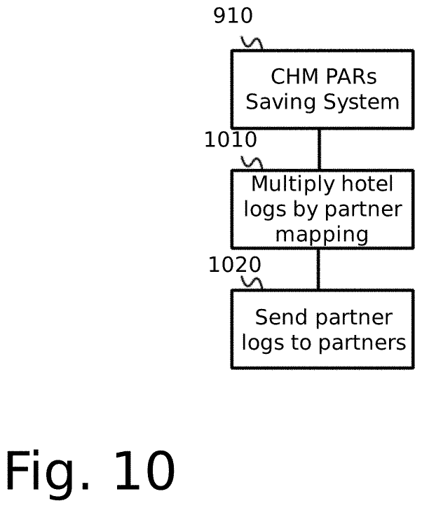

FIG. 10 is a method diagram illustrating the final steps takin in the saving and storing of reservation parameters, according to a preferred aspect. A CHM parameter saving system 910 is present and functions according to FIG. 9, and then multiplies the number of operations of a parameter saving system 910 by the number of partner hotels 1010. For example, if three hotels are linked in a network as partners, this process would be repeated three times, once for each individual hotel. Partner logs are then sent to partner hotels 1020 for storage and usage in the individual hotel.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (“ASIC”), or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines, or other appropriate virtual environments).

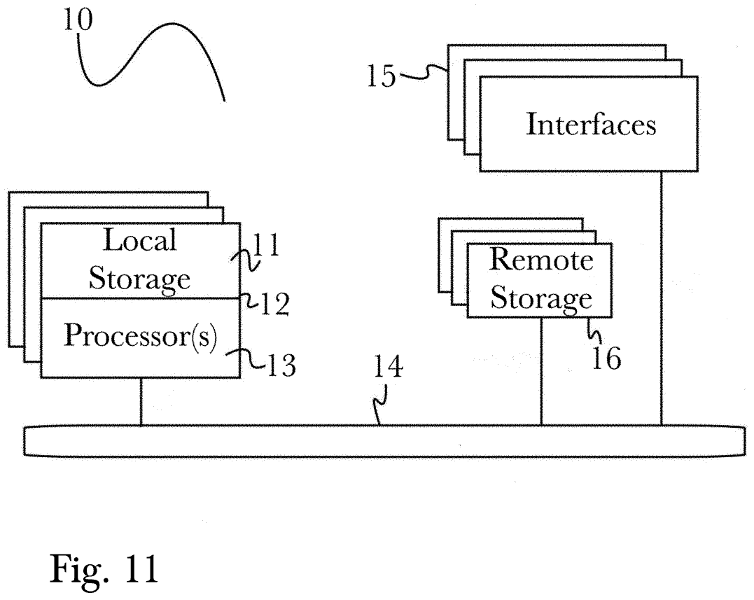

Referring now to FIG. 11, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one embodiment, a computing device 10 may be configured or designed to function as a server system utilizing CPU 12, local memory 11 and/or remote memory 16, and interface(s) 15. In at least one embodiment, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a specific embodiment, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity AN hardware interfaces) and, in some instances, volatile and/or non-volatile memory (e.g., RAM).

Although the system shown in FIG. 11 illustrates one specific architecture for a computing device 10 for implementing one or more of the inventions described herein, it is by no means the only device architecture on which at least a portion of the features and techniques described herein may be implemented. For example, architectures having one or any number of processors 13 may be used, and such processors 13 may be present in a single device or distributed among any number of devices. In one embodiment, a single processor 13 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

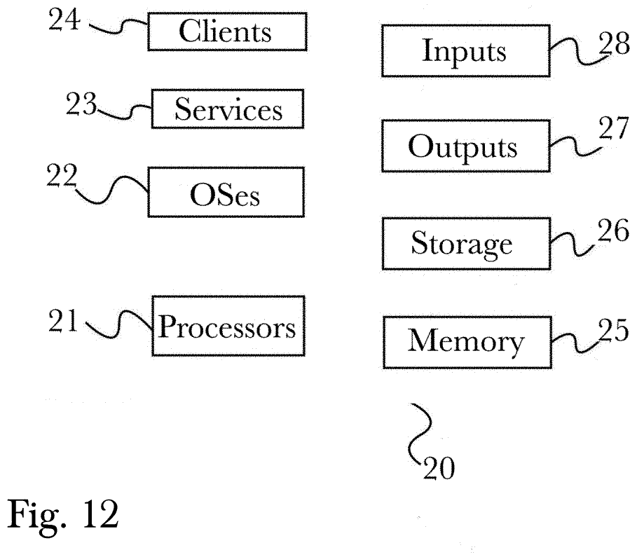

In some embodiments, systems according to the present invention may be implemented on a standalone computing system. Referring now to FIG. 12, there is shown a block diagram depicting a typical exemplary architecture of one or more embodiments or components thereof on a standalone computing system. Computing device 20 includes processors 21 that may run software that carry out one or more functions or applications of embodiments of the invention, such as for example a client application 24. Processors 21 may carry out computing instructions under control of an operating system 22 such as, for example, a version of MICROSOFT WINDOWS™ operating system, APPLE OSX™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 11). Examples of storage devices 26 include flash memory, magnetic hard drive, CD-ROM, and/or the like.

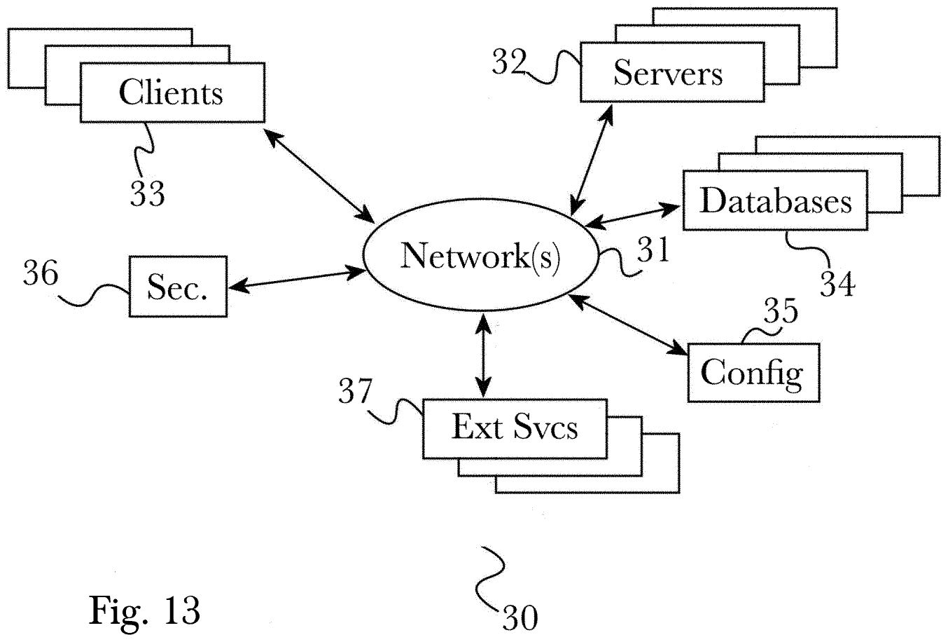

In some embodiments, systems of the present invention may be implemented on a distributed computing network, such as one having any number of clients and/or servers. Referring now to FIG. 13, there is shown a block diagram depicting an exemplary architecture 30 for implementing at least a portion of a system according to an embodiment of the invention on a distributed computing network. According to the embodiment, any number of clients 33 may be provided. Each client 33 may run software for implementing client-side portions of the present invention; clients may comprise a system 20 such as that illustrated in FIG. 12. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the invention does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in an embodiment where client applications 24 are implemented on a smartphone or other electronic device, client applications 24 may obtain information stored in a server system 32 in the cloud or on an external service 37 deployed on one or more of a particular enterprise's or user's premises.

In some embodiments of the invention, clients 33 or servers 32 (or both) may make use of one or more specialized services or appliances that may be deployed locally or remotely across one or more networks 31. For example, one or more databases 34 may be used or referred to by one or more embodiments of the invention. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 36 or configuration system 35 or approach is specifically required by the description of any specific embodiment.

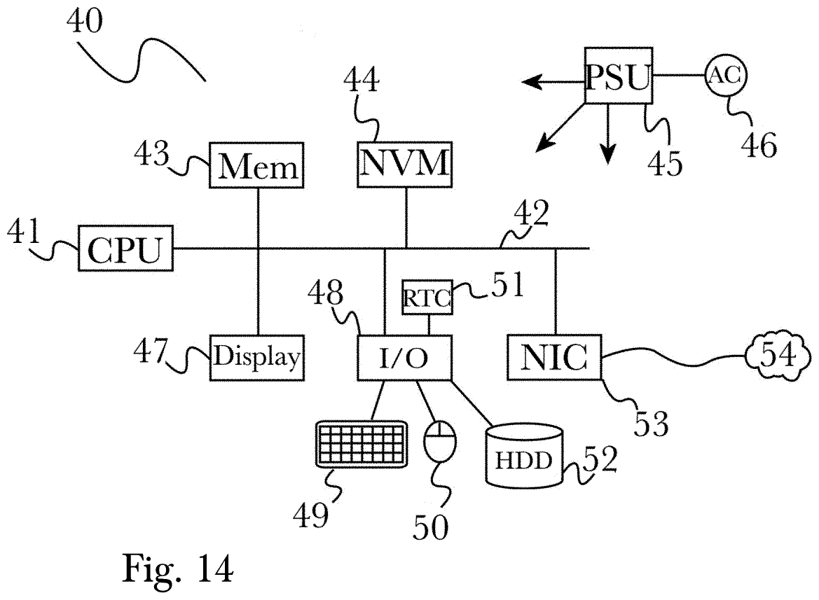

FIG. 14 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

The skilled person will be aware of a range of possible modifications of the various embodiments described above. Accordingly, the present invention is defined by the claims and their equivalents.

What is claimed is:

1. A system for price optimization of stay accommodation reservations using broad and dynamic analyses, comprising:
a property management engine, comprising at least a plurality of programming instructions stored in the memory of, and operating on at least one processor of, a computer system, wherein the plurality of programming instructions, when operating on the processor, cause the computer system to:
receive and store real time information about properties, room availability, and reservations made; and
send the real time information about properties, room availability, and reservations made to a price optimizing engine; and
a price optimizing engine, comprising at least a plurality of programming instructions stored in the memory of, and operating on at least one processor of, a computer system, wherein the plurality of programming instructions, when operating on the processor, cause the computer system to:
obtain a plurality of real time pricing information for short-term stay accommodations;
obtain a plurality of data about external factors, both current and future, that might affect demand for short-term stay accommodations;
dynamically set pricing for short-term stay accommodations based on the plurality of pricing information and the plurality of data about external factors, using machine learning algorithms; and
send pricing and availability information to a booking engine; and
a reservation management engine comprising at least a plurality of programming instructions stored in the memory of, and operating on at least one processor of, a computer system, wherein the plurality of programming instructions, when operating on the processor, cause the computer system to:
receive pricing and availability information from the price optimizing engine;
display the pricing and availability information to potential purchasers or their agents;
allow purchasers or their agents to make short-term stay accommodation reservations based on the displayed pricing and availability information; and
send the reservation information to the property management engine.

2. The system of claim 1, wherein the plurality of real time pricing information comprises:
price and occupancy information for the property at which a reservation is being considered;
price and occupancy information for similar properties owned by competitors; and
market forecasts of price and occupancy.

3. The system of claim 1, wherein the plurality of data about external factors comprises:
data about customer behavior surrounding the booking decision;
data about actual booking, payment, and length of stay by the customer;
data about environmental factors that may affect bookings;
data about events that may affect bookings; and
data about economic factors that may affect bookings.

4. The system of claim 1, wherein a marketplace simulator may be used to simulate a range of marketplace variables, given a single or plurality of optimized pricing options for a parent hotel, wherein the optimized pricing options are refined further based on the outcome of the marketplace simulator.

5. A method for price optimization of stay accommodation reservations using broad and dynamic analyses, comprising the steps of:
receiving and storing information about properties including room availability and current reservations in a given hotel, using a property management engine;
sending real-time information about properties, pricing, and other hotel information, to a price optimization engine;
receiving from either a database or some other network-connected source of digital information, real-time information about accommodations and reservations in a hotel, into a price optimization engine;
receiving from either a database or some other network-connected source of digital information, information about external factors including hotel reviews or inclement weather, that may affect short-term hotel stays, into a price optimization engine;
use machine learning algorithms to dynamically determine optimal pricing for short-term stay accommodations in a hotel based on received external and hotel data;
sending optimal pricing for short-term stay accommodations to a reservation management engine;
displaying pricing and availability information to potential purchasers or their agents using a reservation management engine;
allowing purchasers or their agents to make short-term stay accommodation reservations based on the displayed pricing and availability information; and
sending the reservation information from the reservation management engine to the property management engine.

6. The method of claim 5, wherein the plurality of real time pricing information comprises:
price and occupancy information for the property at which a reservation is being considered;
price and occupancy information for similar properties owned by competitors; and
market forecasts of price and occupancy.

7. The method of claim 5, wherein the plurality of data about external factors comprises:
data about customer behavior surrounding the booking decision;
data about actual booking, payment, and length of stay by the customer;
data about environmental factors that may affect bookings;
data about events that may affect bookings; and
data about economic factors that may affect bookings.

8. The method of claim 5, wherein a marketplace simulator may be used to simulate a range of marketplace variables, given a single or plurality of optimized pricing options for a parent hotel, wherein the optimized pricing options are refined further based on the outcome of the marketplace simulator.
